(19) United States
(12) Patent Application Publication
(10) Pub. No.: US 2004/0179608 A1
(43) Pub. Date: Sep. 16, 2004

(54) Multiple-description coding methods and apparatus

(75) Inventors: Matthew J. Holliman, Cupertino, CA (US); Yen-Kuang Chen, Sunnyvale, CA (US)

Correspondence Address: MARSHALL, GERSTEIN & BORUN LLP, 6300 SEARS TOWER, 233 S. WACKER DRIVE, CHICAGO, IL, 60606, US

(73) Assignee: INTEL CORPORATION, Santa Clara, CA (US)

(21) Appl. No.: 10/377,211

(22) Filed: Feb. 27, 2003

(51) Int. Cl. H04N 7/12

(52) U.S. Cl. 375/240.25; 375/240.03

(57) ABSTRACT

A method for dequantizing quantized data is provided, where the quantized data includes multiple encoded versions of source data. An initial encoding of the source data is received, where the initial encoding includes a sequence of quantized symbols. At least one additional encoding of the source data is received, where the at least one additional encoding includes a sequence of quantized symbols. The initial encoding and the at least one additional encoding are independently encoded. The initial encoding and the at least one additional encoding are aligned. A quantization interval of a symbol in the initial encoding is determined. A quantization interval of a corresponding symbol in the at least one additional encoding is determined. An intersection of the quantization intervals of the symbol in the initial encoding and the corresponding symbol in at least one additional encoding is determined. Based on the intersection, a dequantized symbol is generated.

### FIELD OF THE DISCLOSURE

The present disclosure generally relates to communication systems and, more particularly, to encoding and decoding of data.

### BACKGROUND

Sharing of media between peer systems, as opposed to receiving media from a content delivery network (CDN), is becoming increasingly popular. But the characteristics of peer-to-peer delivery of media can be significantly different than those of delivery by a CDN. For instance, a CDN typically employs a dedicated server or server farm. This generally provides a potentially high bandwidth, high reliability delivery link to a client. Peer-to-peer networks, however, rely on inherently unreliable home computer systems to deliver media. Additionally, home computers are often linked to the network via asymmetrical links. For example, asymmetric digital subscriber line (ADSL) systems and typical cable systems provide upload links with much less bandwidth than their download links. Thus, a home system serving media via a low bandwidth upload link will often not be able to serve the content at a rate required by the client.

Multiple description coding (MDC) generally refers to coding techniques in which multiple, different encodings of data are generated, and one or more of these encodings are transmitted to a receiver. Typically, if the receiver receives only one of the versions of the encoded data, the receiver can decode the data, but with reduced-quality. But if the receiver receives additional versions of the encoded data, the receiver can regenerate the original data with increased quality. Generally, the more versions received, the higher the quality of the regenerated data.

### BRIEF DESCRIPTION OF THE DRAWINGS

The features and advantages of the coding systems and methods described herein will be best appreciated upon reference to the following detailed description and the accompanying drawings, in which:

FIG. 1 is a block diagram illustrating an MPEG encoder;

FIG. 2 is a block diagram illustrating an MPEG decoder;

FIG. 3 is a block diagram of an example quantizer;

FIG. 4 is a flow diagram of an example method for quantizing symbols;

FIG. 5 is a block diagram of an example coding system that may utilize the example quantizer of FIG. 3;

FIG. 6 is a block diagram of a portion of an example decoder;

FIG. 7 is a block diagram of one an example dequantizer;

FIG. 8 is a diagram graphically illustrating example relationships between unquantized symbols, quantized symbols, and quantization intervals;

FIG. 9 is a flow diagram of an example method for dequantizing quantized data;

FIG. 10 is a block diagram of an example encoder;

FIG. 11 is a flow diagram of an example method for encoding data;

FIG. 12 is a block diagram of another example decoder;

FIG. 13 is a flow diagram of an example method for decoding symbols;

FIG. 14 is a block diagram of an example network environment;

FIG. 15 is a block diagram of another example network environment;

FIG. 16 is a flow diagram of an example method that may be implemented in the example system of FIG. 15; and

FIG. 17 is a flow diagram of another example method that may be implemented in the example system of FIG. 15.

### DETAILED DESCRIPTION

### Coding of Video

For ease of illustration, the following examples are described in the context of motion picture experts group (MPEG) coding techniques for encoding and decoding video (e.g., the MPEG-1 standard (ISO/IEC 1172-2:1993, published 1993, ISO/IEC 1172-2:1993/Cor. 1:1996, published 1996, ISO/IEC 1172-2:1993/Cor. 2:1999, published 1999), the MPEG-2 standard (ISO/IEC 13818-2:2000, published 2000), the MPEG-4 standard (ISO/IEC 14496-2:2001), etc.). It is to be understood, however, that other coding techniques and/or other types of data could also be used (e.g., image data and image coders, audio data and audio coders, etc.).

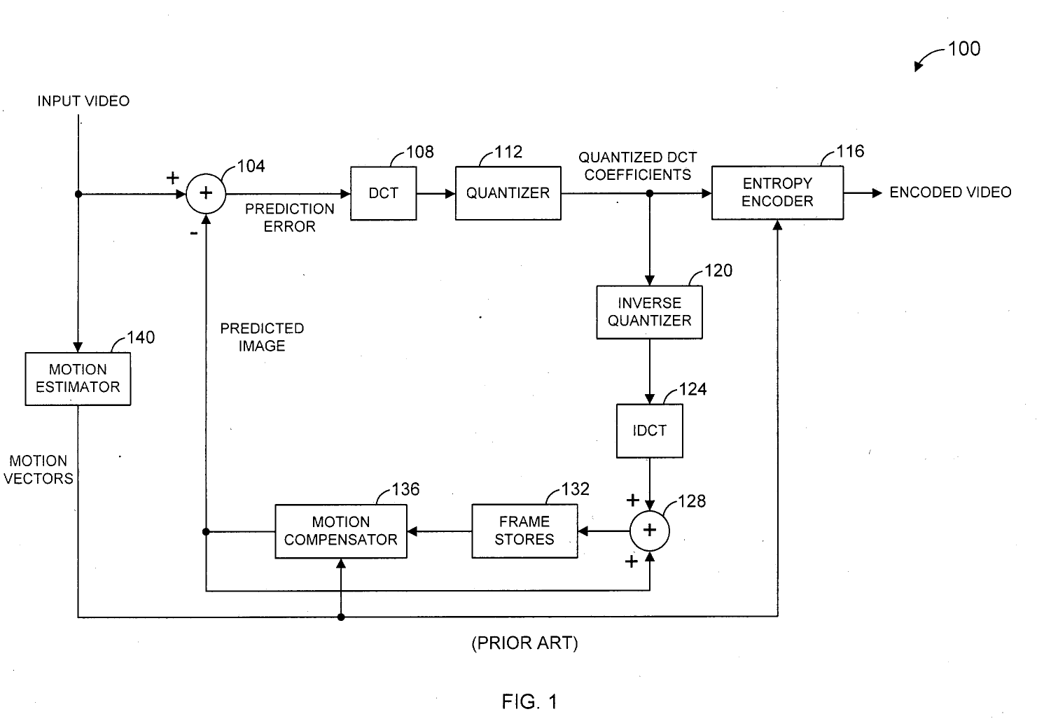

FIG. 1 illustrates a prior art MPEG encoder 100 for encoding video data. Encoder 100 includes a subtractor 104 that receives a sequence of images (input video) and a sequence of predicted images. The input video is also provided to a motion estimator 140 that generates motion vectors. Subtractor 104 subtracts from each image its corresponding predicted image to generate prediction error data. The prediction error data is transformed with a discrete cosign transform (DCT) 108 to generate DCT coefficients. A quantizer 112 quantizes the DCT coefficients. An entropy encoder 116 encodes the quantized DCT coefficients, as well as motion vectors, to form encoded video data.

The quantized DCT coefficients are also provided to an inverse quantizer 120 that dequantizes the DCT coefficients, and an inverse DCT (IDCT) 124 is performed to regenerate the prediction error. The regenerated prediction error is provided to an adder 128, which also receives the predicted images. Adder 128 regenerates images which are provided to frame stores 132. A motion compensator 136 generates the predicted images using both the images in frame stores 132 and the motion vectors generated by motion estimator 140.

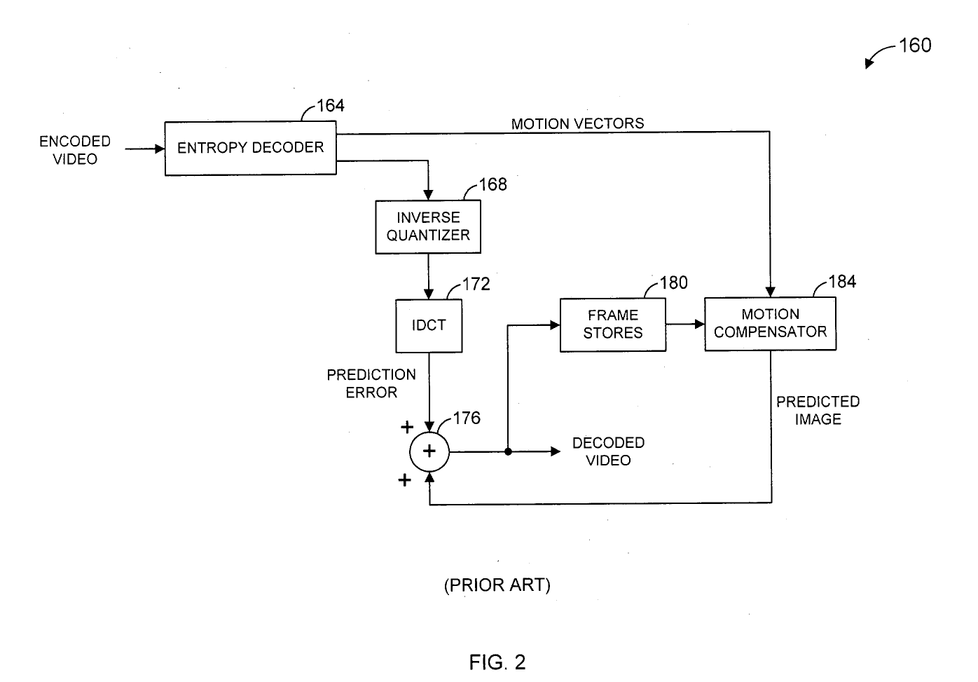

FIG. 2 is a block diagram of a prior art MPEG decoder 160. Decoder 160 includes an entropy decoder 164 that decodes the encoded video to produce motion vectors and quantized DCT coefficients. An inverse quantizer 168 dequantizes the quantized DCT coefficients, and an IDCT 172 is performed to regenerate the prediction error. An adder 176 adds the prediction error with predicted images to generate the decoded video. Additionally, images of the decoded video are stored in frame stores 180. A motion compensator 184 generates predicted images using the motion vectors and images from frame stores 180.

### Multiple-Description Quantizer

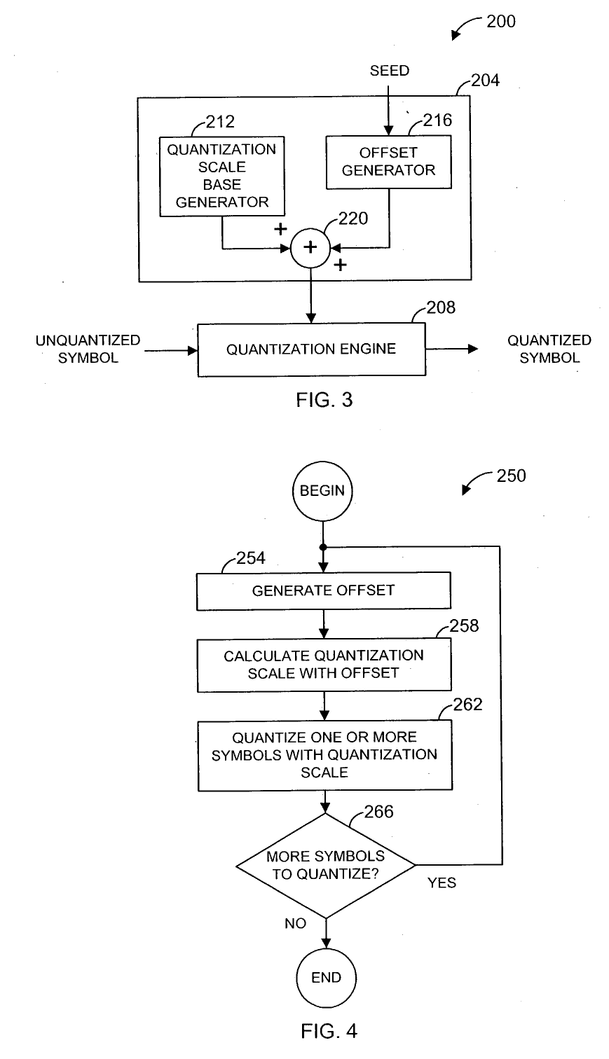

FIG. 3 is a block diagram of an example quantizer 200 that can be used in place of quantizer 112 of FIG. 1. Quantizer 200 comprises a quantization scale generator 204 and a quantization engine 208. Quantization scale generator 204 generates a quantization scale value which is provided to quantization engine 208. Quantization engine 208 quantizes data based on the quantization scale in any number of ways well known to those of ordinary skill in the art.

Quantization scale generator 204 comprises a quantization scale base generator 212, an offset generator 216, and an adder 220. Quantization scale base generator 212 generates a base quantization scale which is provided to adder 220. The base quantization scale can be generated using any number of techniques well known to those of ordinary skill in the art. For example, the base quantization scale can be generated as would be a quantization scale in a typical, prior art, MPEG encoder.

Offset generator 216 generates a randomly or pseudo-randomly varying offset value that is provided to adder 220. In some examples, offset generator 216 is provided with a seed for use in generating a pseudo-randomly varying offset value. A different offset may be generated for each symbol to be quantized, for every x symbols, where x is some integer greater than 1, etc. In some examples, offset generator 216 generates a varying offset value drawn from a normal (Gaussian) distribution of zero-mean and a variance. The variance may be chosen based on an expected number of streams that will be received by a decoder. The expected number of streams that will be received by a decoder may be estimated or determined, for example, for all decoders or a subset of decoders ahead of time, on a case-by-case basis, etc. Such a determination may be made in an ad hoc fashion, based on measurements, etc. Generally speaking, as the number of received streams increases, a larger variance should produce a better quality reproduced signal than a smaller variance. But if the number of received streams is, for example, one or two, a larger variance should produce a worse quality reproduced signal than a smaller variance.

Additionally, the variance may be, alternatively or additionally, based on the base quantization scale. In one particular implementation, the variance may be set at 20% of the quantization scale. In other implementations, the variance may be set at 10%, 15%, 25%, 30%, etc. of the quantization scale.

In examples in which a seed is provided to offset generator 216, the seed may be constant or may vary with time.

Adder 220 adds the base quantization scale and the offset to generate the quantization scale value.

In operation, quantizer 200 quantizes symbols in a manner similar to a typical quantizer. However, the degree of quantization varies randomly or pseudo-randomly as the symbols are quantized.

An example software program for implementing the apparatus of FIG. 3 is shown in FIG. 4. In this example, the program is for execution by a processor and is embodied in software stored on a tangible medium such as CD-ROM, a floppy disk, a hard drive, a digital versatile disk (DVD), or a memory associated with the processor, but persons of ordinary skill in the art will readily appreciate that the entire program or parts thereof could alternatively be executed by a device other than a processor, and/or embodied in firmware and/or dedicated hardware in a well known manner. For example, any or all of quantization scale base generator 212, offset generator 216, adder 220, or quantization engine 208 could be implemented by software, hardware, and/or firmware. Further, although the example program is described with reference to the flow diagram in FIG. 4, persons of ordinary skill in the art will readily appreciate that many other methods of implementing the apparatus 200 of FIG. 3 may alternatively be used. For example, the order of execution of the blocks may be changed, and/or the blocks may be changed, eliminated, or combined.

FIG. 4 is a flow diagram of an example method for implementing the example quantizer 200 of FIG. 3. At block 254, an offset is randomly or pseudo-randomly generated by offset generator 216. A quantization scale value is then calculated with the offset (block 258). For example, as described above, a quantization scale can be by adder 220 by adding a base quantization scale with the offset. Quantization engine 208 then quantizes one or more symbols using the calculated quantization scale value. If more symbols need to be quantize (block 266), control returns to block 254. Otherwise, the routine ends.

### A System Employing the Multiple-Description Quantizer

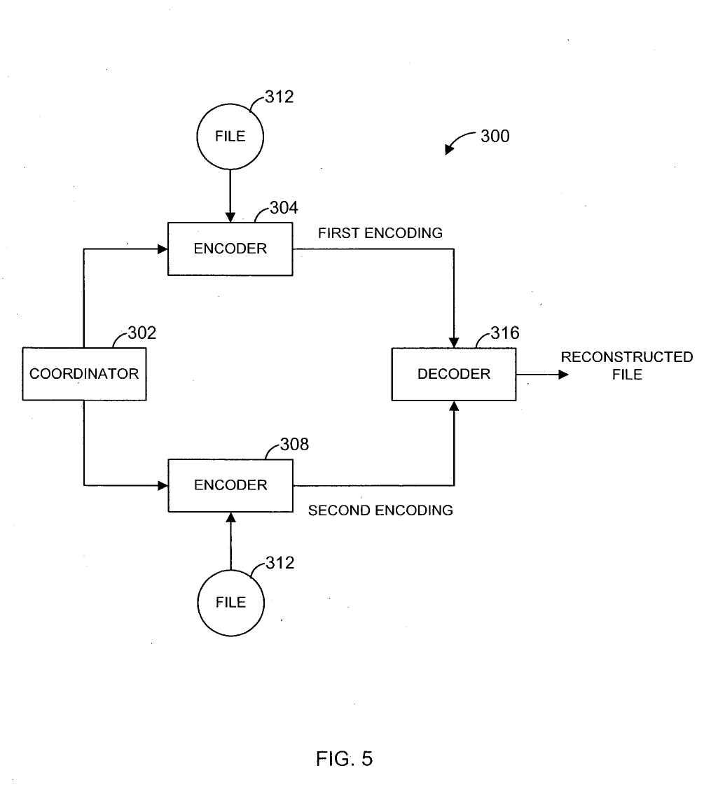

FIG. 5 is a block diagram of an example coding system that may utilize the quantizer 200 of FIG. 3. System 300 encodes a file 312 into multiple encoded versions of the file. A decoder 316 receives one or both of the encoded versions and regenerates the file using the received encoded version(s).

The illustrated system 300 includes a coordinator 302 and encoders 304 and 308. In one example, encoders 304 and 308 are MPEG encoders such as encoder 100 of FIG. 1, but with quantizer 200 of FIG. 3 replacing quantizer 112.

Under the control of coordinator 302, encoder 304 generates a first encoding of data file 312 with a randomly or pseudo-randomly varying quantization scale. Additionally, encoder 308, under the control of coordinator 302, generates a second encoding of data file 312 with a randomly or pseudo-randomly varying quantization scale which varies independently than that of encoder 304. In examples in which encoders 304 and 308 include quantizers that use seeds to pseudo-randomly vary their respective quantization scale values, coordinator 302 may control encoders 304 and 308 by providing them with respective seeds. Additionally, in some examples, coordinator 302 may control encoders 304 and 308 to encode and/or transmit to decoder 316 their respective encodings of file 312 at substantially the same time. In other examples, coordinator 302 may control encoders 304 and 308 to encode and/or transmit to decoder 316 their respective encodings of file 312 at substantially different times.

Decoder 316 receives one or both of the first encoding and the second encoding from encoders 304 and 308, respectively. In some examples, if decoder 316 receives only one of the encodings, decoder 316 can regenerate a reduced quality version of file 312 as will become clear to one of ordinary skill in the art from the description below. If decoder 316 receives both of the encodings, decoder 316 can regenerate a version of file 312 that is of better quality than if only one of the encodings were received as will become clear to one of ordinary skill in the art from the description below. Similarly, if additional encoders (not shown) are employed, and decoder 316 receives three or more encodings, the quality of the reconstructed file could be even further improved as will become clear to one of ordinary skill in the art from the description below.

Additionally, although multiple encoders are illustrated in FIG. 5, it will be understood by those of ordinary skill in the art that, alternatively, one encoder can be used to generate multiple encodings of file 312. For example, in examples in which a seed is used to pseudo-randomly vary the quantization scale value, a single encoder can generate a first encoding with a first seed and store the first encoding, for example, on a disk. Then, the same encoder can generate a second encoding with a second seed. Next, the first encoding and second encoding can be transmitted via one or more links to decoder 316.

In some examples, coordinator 302 is implemented on a computing system separate from those that implement encoders 304 and 308 and decoder 316. In other examples, coordinator 302 is implemented on the same computing system as used to implement encoders 304 and 308 or decoder 316. In still other examples, coordinator 302 is distributed and implemented by multiple computing systems. For instance, coordinator 302 may be implemented by two or more computing systems that implement encoders 304 and 308 or decoder 316.

In another example, coordinator 302 may be omitted. For instance, encoders 304 and 308 may encode file 312 and transmit it to the decoder 316 in response to a request from the decoder 316. Further, encoders 304 and 308 could each randomly or pseudo-randomly generate a seed so that each may pseudo-randomly vary their respective quantization scales.

### Multiple-Description Decoder

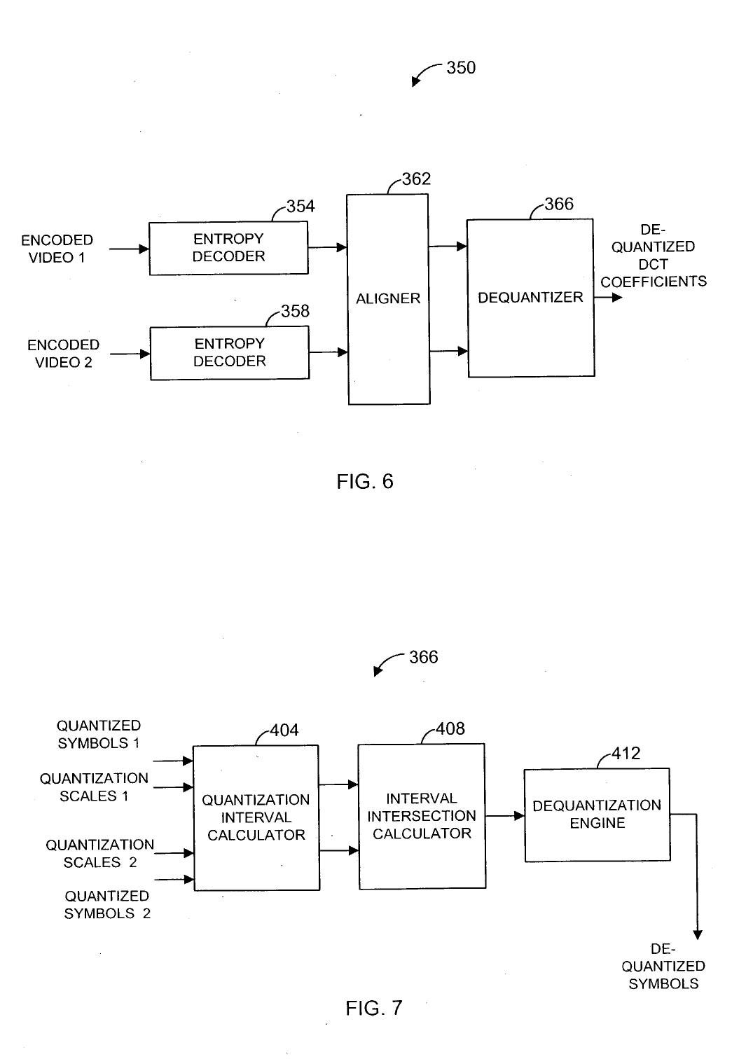

In the context of MPEG coding, a typical MPEG decoder such as decoder 160 of FIG. 2 can be modified as shown in FIG. 6. In the example of FIG. 6 a subsystem 350 replaces entropy decoder 164 and inverse quantizer 172 of FIG. 2.

Subsystem 350 includes two entropy decoders 354 and 358, an aligner 362, and a dequantizer 366. Each of entropy decoders 354 and 358 can receive a different encoding of video and generate a respective sequence of quantized DCT coefficients. If it is desired that a decoder be capable of receiving three or more encodings, more entropy decoders can be included. Alternatively, some examples may employ only one entropy decoder. In these examples, if the sole entropy decoder is occupied with a first video encoding and one or more additional video encodings are received, the additional video encoding(s) can be stored, for example, to a disk. When the single entropy decoder is finished decoding the first video encoding, it can begin decoding the additional video encoding(s) by reading them from the disk. In another example, multiple video encodings can be buffered as they are received, and the entropy decoder can decode the multiple video encodings, for example, on a time-share basis.

It will be understood by those of ordinary skill in the art that, although subsystem 350 may be configured to be capable of receiving a particular number of encodings, subsystem 350 may not receive that number of encodings and may still be able to decode the data. For example, although subsystem 350 is shown configured to receive two encodings, it may still be able to decode data if it only receives one encoding. In these instances, the quality of the decoded data may be less than if multiple encodings had been received.

Aligner 362 aligns the sequences of DCT coefficients generated by entropy decoders 354 and 358. In particular, aligner 362 generates multiple sequences of DCT coefficients that are synchronized. Thus, if one video encoding was delayed with respect to the other, aligner 362 compensates for that delay. Aligner 362 may align the sequences using, for example, watermarks embedded in the encodings, correlation techniques, etc.

Dequantizer 366 receives the multiple, aligned sequences of quantized DCT coefficients and generates a sequence of dequantized DCT coefficients. An example dequantizer 366 is shown in FIG. 7. FIG. 7 is a block diagram of one Dequantizer 366 includes a quantization interval calculator 404, and interval intersection calculator 408, and a dequantization engine 412. Quantization interval calculator 404 receives a first sequence of quantized symbols (QUANTIZED SYMBOLS 1) and its corresponding quantization scale values (QUANTIZATION SCALES 1). Additionally, quantization interval calculator 404 receives a second sequence of quantized symbols (QUANTIZED SYMBOLS 2) and its corresponding quantization scale values (QUANTIZATION SCALES 2). The quantization scale values can be provided in a number of formats. For example, a quantization scale can be provided for each quantized symbol. Also, a base quantization scale can be provided for multiple quantized symbols, and a quantization offset can be provided for each of those quantized symbols. Additionally, a base quantization scale can be provided for multiple quantized symbols, and a seed can be provided for regenerating the pseudo-randomly varying offsets. A person of ordinary skill in the art will recognize other techniques for providing quantization scale information to quantization interval calculator.

For each quantized symbol in the first sequence, quantization interval calculator 404 generates a quantization interval for that quantized symbol based on its corresponding quantization scale. Similarly, for each quantized symbol in the second sequence, quantization interval calculator 404 generates a quantization interval for that quantized symbol based on its corresponding quantization scale.

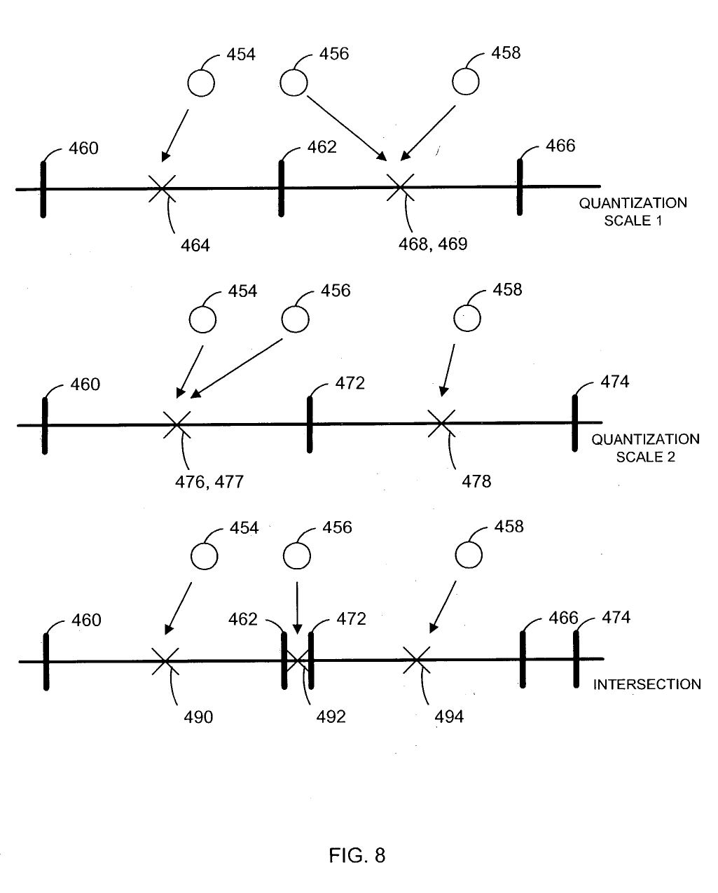

A quantization interval for a given quantized symbol and quantization scale is the range of unquantized values from which the quantized value may have been derived. FIG. 8 is a diagram graphically illustrating example relationships between unquantized symbols, quantized symbols, and quantization intervals. In this diagram, circles represent unquantized symbols, and X's represent quantized symbols. FIG. 8 illustrates the quantization of symbols 454, 456, and 458 according to two different quantization scales. In this example, the quantization intervals labeled QUANTIZATION SCALE 1 correspond to a first quantization scale value, and the quantization intervals labeled QUANTIZATION SCALE 2 correspond to a second quantization scale value.

For instance, for a first quantization scale, any unquantized symbols between the values 460 and 462 will be quantized to 464, and any unquantized symbols between the values 462 and 466 will be quantized to a symbol 468. For a second quantization scale, any unquantized symbols between the values 460 and 472 will be quantized to a symbol 476, and any unquantized symbols between the values 472 and 474 will be quantized to a symbol 478. Thus, with the first quantization scale, symbol 454 is quantized to symbol 464, symbol 456 is quantized to symbol 468, and symbol 458 is quantized to symbol 469 which, in this example, has the same value as symbol 468. With the second quantization scale, symbol 454 is quantized to symbol 476, symbol 456 is quantized to symbol 477, and symbol 458 is quantized to symbol 478. For the first quantization scale, end points 460 and 462 define the quantization interval corresponding to quantized symbol 464, and end points 462 and 466 define the quantization interval corresponding to quantized symbols 468 and 469. For the second quantization scale, end points 460 and 472 define the quantization interval corresponding to quantized symbols 476 and 477, and end points 472 and 474 define the quantization interval corresponding to quantized symbol 478.

Referring again to FIG. 7, interval intersection calculator 408 receives quantization intervals and generates an intersection of the quantization. The diagram of FIG. 8 graphically illustrates examples of quantization intervals and intersections of quantization intervals. As described above, circles 454, 456, and 458 represent unquantized symbols, and X's 464, 468, 469, 476, 477, and 478 represent the quantized versions of these symbols.

For the first quantization scale, quantization interval defined by the endpoints 460/462 corresponds to symbol 454. On the other hand, for the second quantization scale, quantization interval defined by the endpoints 460/472 corresponds to symbol 454 The intersection of these two intervals is the interval defined by the endpoints 460/462. Similarly, the intersection of the two quantization intervals corresponding to symbol 456 is the interval defined by the endpoints 462/472, and the intersection of the two quantization intervals corresponding to symbol 458 is the interval defined by the endpoints 472/466. Referring now to FIGS. 7 and 8, if interval intersection calculator 408 receives, as an example, indications of intervals 460/462 and 460/472 corresponding to unquantized symbol 454, it generates an indication of the intersection interval 460/462. Similarly, if interval intersection calculator 408 receives indications of intervals 462/466 and 460/472 corresponding to unquantized symbol 456, it generates an indication of the intersection interval 462/472. Additionally, if interval intersection calculator 408 receives indications of intervals 462/466 and 472/474 corresponding to unquantized symbol 458, it generates an indication of the intersection interval 472/466.

In implementations in which symbol encoding includes prediction, a symbol X may be represented as a predicted symbol P plus an error E. The decoder may receive the error E, calculate the predicted symbol P, and then generate the symbol X based on E and P (e.g., by adding E to P). In some of these implementations, dequantization may be performed on the symbol X (i.e., after the addition of P and E). For example, in video coding that employs DCT-domain motion prediction/compensation, dequantization may be implemented after adding P to E (i.e., the symbol X is dequantized).

In these implementations, the quantization interval of X may be determined based on the quantization intervals of P and E. For example, if the quantization interval of P is [Pmin, Pmax] and the quantization interval of E is [Emin, Emax], the quantization interval of X may be determined as [Pmin+Emin, Pmax+Emax]. Moreover, if P is itself based on a predicted symbol, the quantization interval of P may have been determined similarly. For example, if P was calculated based on P′ and E′, Pmin may be determined as P′min+E′min, and Pmax may be determined as P′max+E′max. Similarly, if X is used subsequently as a prediction for another symbol, its quantization interval (i.e., [Pmin+Emin, Pmax+Emax]) may be used to determine the quantization interval of the symbol for which it is being used to predict.

In many typical dequantizers, a dequantized value is calculated as the centroid of a quantization interval. In these dequantizers, the errors added in the dequantization process are generally reduced when the size of the quantization intervals are reduced. As can be seen in the example of FIG. 8, the intersection of quantization intervals according to two different quantization scales is generally smaller than any one of the quantization intervals. Thus, the computing the intersection of two or more quantization intervals should, on average, reduce dequantization errors.

Referring now to FIG. 7, dequantization engine 412 receives indications of intersections of quantization intervals, and generates dequantized symbols based on those intersections. In an example, dequantization engine 412 generates a dequantized symbol as the centroid of the interval. In the example of FIG. 8, the centroids of intervals 460/462, 462/472, and 472/466 are merely their respective mid-points. Thus, in this example, dequantization engine 412 receives indications of intersection intervals, and generates dequantized symbols as the mid-points of those intersection intervals.

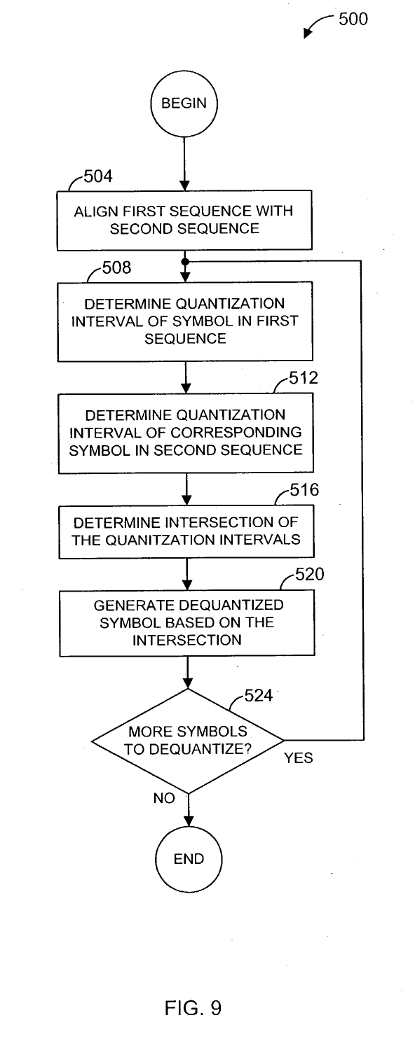

An example software program for implementing the apparatus of FIGS. 6 and 7 is shown in FIG. 9. In this example, the program is for execution by a processor and is embodied in software stored on a tangible medium such as CD-ROM, a floppy disk, a hard drive, a digital versatile disk (DVD), or a memory associated with the processor, but persons of ordinary skill in the art will readily appreciate that the entire program or parts thereof could alternatively be executed by a device other than a processor, and/or embodied in firmware and/or dedicated hardware in a well known manner. For example, any or all of entropy decoders 354, 358, aligner 362, quantization interval calculator 404, interval intersection calculator 408, or dequantization engine 412 could be implemented by software, hardware, and/or firmware. Further, although the example program is described with reference to the flow diagram in FIG. 9, persons of ordinary skill in the art will readily appreciate that many other methods of implementing the apparatus 350 of FIG. 6 and apparatus 366 of FIG. 7 may alternatively be used. For example, the order of execution of the blocks may be changed, and/or the blocks may be changed, eliminated, or combined.

FIG. 9 is a flow diagram of an example method 500 for implementing dequantizer 366 of FIG. 7. At block 504, aligner 362 aligns a first sequence of quantized symbols with a second sequence of quantized symbols, where the first and second sequences are two different quantized versions of a sequence of symbols.

At block 508, quantization interval calculator 404 determines the quantization interval of a quantized symbol in the first sequence. At block 512, quantization interval calculator 404 determines the quantization interval of a quantized symbol in the second sequence, where the quantized symbol in the second sequence corresponds to the quantized symbol in the first sequence of block 508. As described above, a quantization interval can be determined based on a received indication of the quantization scale corresponding to that quantized symbol.

At block 516, interval intersection calculator 408 determines the intersection of the intervals determined at blocks 508 and 512. The intersection of two or more intervals can be determined in any number of ways known to those of ordinary skill in the art. At block 520, a dequantized symbol is generated based on the intersection determined in block 516. In some examples, the dequantized symbol is generated as the centroid of the intersection interval. If more symbols need to be dequantized (block 524), control returns to block 508. Otherwise, the flow ends.

### Another Multiple-Description Encoding Technique

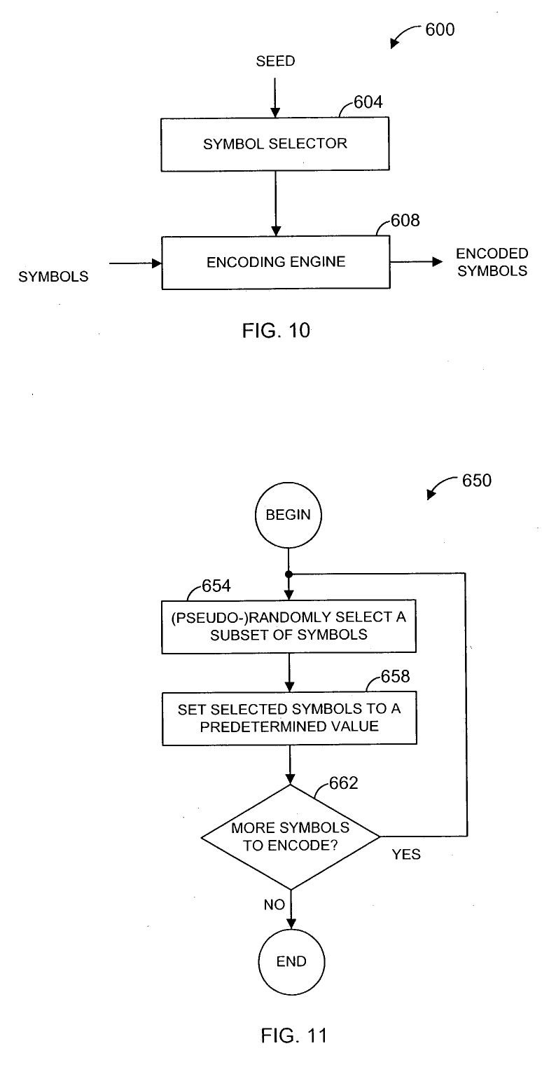

FIG. 10 is a block diagram of an example encoder 600. Encoder 600 includes a symbol selector 604 and an encoding engine 608. Symbol selector 604 randomly or pseudo-randomly selects symbols in a sequence of symbols. In some examples, symbol selector 604 generates indications of the selected symbols. In an example, symbol selector 604 receives a seed and, based on the seed, pseudo-randomly selects symbols in the sequence of symbols. The seed may be constant or time-varying.

Encoding engine 608 receives the sequence of symbols, and sets symbols indicated by symbol selector 604 to a predetermined value. In some examples, encoding engine 608 receives indications of the symbols to be set to the predetermined value from symbol selector 604. The output of encoding engine 608 is the sequence of symbols with certain of the symbols set to the predetermined value. For example, the predetermined value can be zero.

An example software program for implementing the apparatus of FIG. 10 is shown in FIG. 11. In this example, the program is for execution by a processor and is embodied in software stored on a tangible medium such as CD-ROM, a floppy disk, a hard drive, a digital versatile disk (DVD), or a memory associated with the processor, but persons of ordinary skill in the art will readily appreciate that the entire program or parts thereof could alternatively be executed by a device other than a processor, and/or embodied in firmware and/or dedicated hardware in a well known manner. For example, any or all of symbol selector 604 and encoding engine 608 could be implemented by software, hardware, and/or firmware. Further, although the example program is described with reference to the flow diagram in FIG. 11, persons of ordinary skill in the art will readily appreciate that many other methods of implementing the apparatus 600 of FIG. 10 may alternatively be used. For example, the order of execution of the blocks may be changed, and/or the blocks may be changed, eliminated, or combined.

FIG. 11 is a flow diagram of an example method for encoding data. At block 654, symbol selector 604 randomly or pseudo-randomly selects a subset of symbols in a sequence of symbols. At block 658, encoding engine 608 sets the selected subset of symbols to a predetermined value. As described above, the predetermined value can be zero. If more symbols are to be encoded, control returns to block 654. Otherwise, the flow ends.;

Referring now to FIGS. 1, 10, and 11, encoder 600 and/or method 650 could be incorporated into an MPEG encoder such as MPEG encoder 100. For instance, encoder 600 could be incorporated into quantizer 112, after quantizer 112 and before both entropy encoder 116 and inverse quantizer 120, or prior to entropy encoder 116, but not prior to inverse quantizer 120. If encoder 600 is not incorporated prior to inverse quantizer 120, and/or method 650 is not applied to the input of inverse quantizer 120, drift errors may occur at a decoder receiving the encoded video.

In some examples, the predetermined value is zero. In these examples, setting some of the symbols to zero permits entropy encoder 116 to compress the data further than it would otherwise. Thus, encoder 600 can help reduce the amount of data, the data rate, etc. of the encoded data.

Referring now to FIGS. 5 and 10, system 300 is an example coding system that may utilize an encoder such as encoder 600 of FIG. 10. As described previously, system 300 encodes a file 312 into multiple encoded versions of the file. A decoder 316 receives one or both of the encoded versions and regenerates the file using the received encoded version(s).

Encoders 304 and 308 can include encoders such as encoder 600. Under the control of coordinator 302, encoder 304 generates a first encoding of data file 312 with a first subset of symbols from data file 312, selected randomly or pseudo-randomly, set to a predetermined value. Additionally, encoder 308, under the control of coordinator 302, generates a second encoding of data file 312 with a second subset of symbols from data file 312, selected randomly or pseudo-randomly, set to the predetermined value. In examples in which encoders 304 and 308 include encoders 600 that use seeds to pseudo-randomly select symbols, coordinator 302 may provide respective seeds to encoders 304 and 308. Additionally, in some examples, coordinator 302 may control encoders 304 and 308 to encode and/or transmit to decoder 316 their respective encodings of file 312 at substantially the same time. In other examples, encoders 304 and 308 coordinator 302 may control encoders 304 and 308 to encode and/or transmit to decoder 316 their respective encodings of file 312 at substantially different times.

Decoder 316 receives one or both of the first encoding and the second encoding from encoders 304 and 308, respectively. In some examples, if decoder 316 receives only one of the encodings, decoder 316 can regenerate a reduced quality version of file 312. As will be described below, if decoder 316 receives both of the encodings, decoder 316 can regenerate a version of file 312 that is of better quality than if only one of the encodings were received.

### Another Multiple-Description Decoder

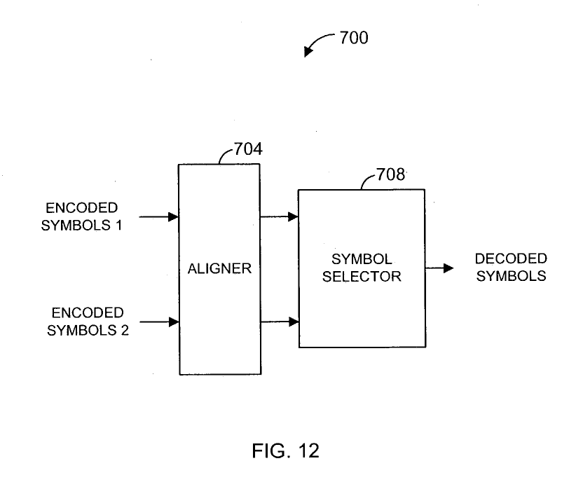

FIG. 12 is a block diagram of another example decoder 700 that can be used in systems that employ encoding techniques such as those described with reference to FIGS. 10 and 11. Decoder 700 includes an aligner 704 and a symbol selector 708. Aligner 704 is configured to receive multiple sequences of encoded symbols. For ease of illustration, aligner 704 is shown in FIG. 12 receiving two sequences, but aligner 704 may receive only one sequence, or more than two. The two sequences illustrated in FIG. 12 correspond to two different encodings of substantially the same data. In each sequence, randomly or pseudo-randomly selected symbols have been set to a predetermined value. Aligner 704 aligns the two sequences to generate two synchronized sequences of encoded symbols.

Symbol selector 708 receives the two synchronized sequences of encoded symbols. For each pair of encoded symbols, symbol selector 708 examines the symbol from the first sequence. If it is not of the predetermined value, symbol selector 708 selects this symbol as the decoded symbol output. If it is of the predetermined value, symbol selector 708 selects the corresponding symbol from the second sequence as the decoded symbol output.

In other examples, if the symbol from the first sequence and the symbol from the second sequence are both not of the predetermined value, then the decoded symbol can be generated as some function of the symbol from the first sequence and the symbol from the second sequence.

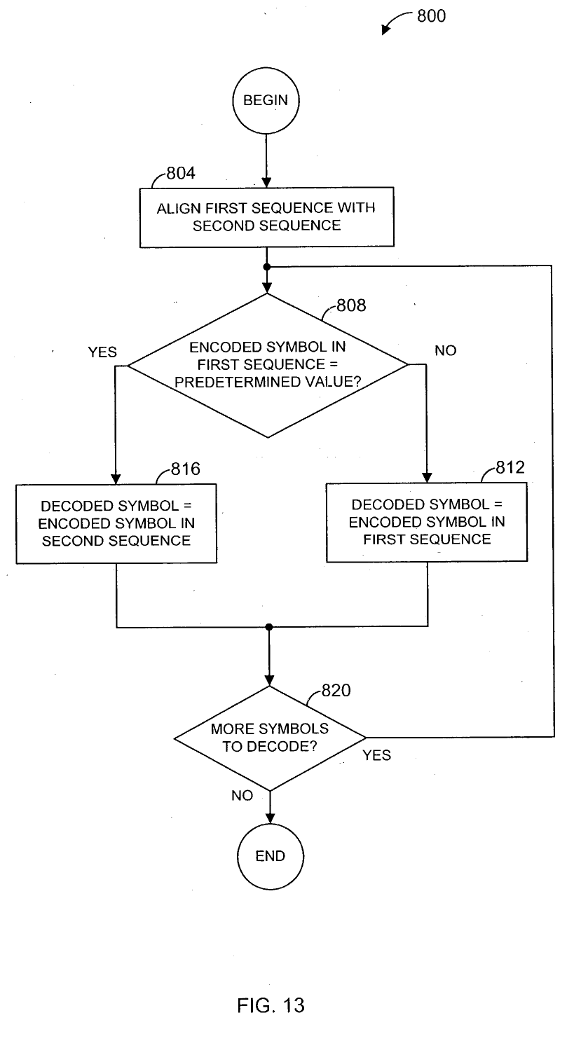

An example software program for implementing the apparatus of FIG. 12 is shown in FIG. 13. In this example, the program is for execution by a processor and is embodied in software stored on a tangible medium such as CD-ROM, a floppy disk, a hard drive, a digital versatile disk (DVD), or a memory associated with the processor, but persons of ordinary skill in the art will readily appreciate that the entire program or parts thereof could alternatively be executed by a device other than a processor, and/or embodied in firmware and/or dedicated hardware in a well known manner. For example, any or all of aligner 704 and symbol selector 708 could be implemented by software, hardware, and/or firmware. Further, although the example program is described with reference to the flow diagram in FIG. 13, persons of ordinary skill in the art will readily appreciate that many other methods of implementing the apparatus 700 of FIG. 12 may alternatively be used. For example, the order of execution of the blocks may be changed, and/or the blocks may be changed, eliminated, or combined.

FIG. 13 is a flow diagram of an example method for decoding symbols from first and second sequences. In the two sequences, which have been generated from substantially the same data, randomly or pseudo-randomly selected symbols have been set to a predetermined value. At block 804, aligner 704 aligns the first and second sequences. At block 808, symbol selector 708 examines a symbol from the first sequence. If the symbol is not of the predetermined value, control proceeds to block 812. At block 812, the decoded symbol is set as the symbol from the first sequence, and control proceeds to block 820. If, at block 808, symbol selector 708 determines the symbol from the first sequence is of the predetermined value, then, at block 816, symbol selector 708 sets the decoded symbol as the corresponding symbol from the second sequence. Next, control proceeds to block 820. If there are more symbols to decode (block 820), control returns to block 808. Otherwise, the flow ends.

As with the example described with respect to FIG. 12, in some other examples, if the symbol from the first sequence and the symbol from the second sequence are both not of the predetermined value, then the decoded symbol can be generated as some function of the symbol from the first sequence and the symbol from the second sequence.

The examples described with reference to FIGS. 12 and 13 decoded symbols from two sequences. It is to be understood that in other examples, more than two sequences can be used to decode the symbols. For example, in some examples, if a symbol from the first sequence is of the predetermined value, and if multiple corresponding symbols from the other sequences are not of the predetermined value, the decoded symbol can be generated by deterministically selecting, or randomly or pseudo-randomly selecting one of the other multiple corresponding symbols. Also, if more than one of the multiple corresponding symbols from the plurality of symbols is not of the predetermined value, the decoded symbols could be generated as some function of those symbols. Further, if only one sequence is received, the decoded symbols may be able to be generated solely from this received sequence.

### Variations

In some examples, a data file to be encoded by multiple encoders may include noise, where the noise at each encoder is independent of the noise at the other encoders. For instance, an analog television (TV) signal of a TV show may be received and digitized by multiple computer systems. The digitized TV show at each computer system may include noise that is independent of the noise at the other computer systems. In these examples, if each computer system includes an encoder that makes independent encoding decisions, the independent noise at each computer system may be enough to independently perturb quantization scales at the computer systems. The independent perturbation of the quantization scales due to the noise may produce multiple encoded versions of the TV show similar, in effect, to the encoding techniques described with reference to FIGS. 3-5. Thus, in these instances, the quantization techniques described with reference to FIGS. 3-4 may not be needed.

In some examples, encoding techniques such as those described with reference to FIGS. 3 and 4 can be combined with techniques such as those described with reference to FIGS. 10 and 11. For instance, during encoding of symbols, the quantization scale values can be randomly or pseudo-randomly varied as described with reference to FIGS. 3 and 4. Additionally, randomly or pseudo-randomly selected symbols may be set to a predetermined value. In such examples, decoding techniques such as those described with reference to FIGS. 6 and 7 can be combined with decoding techniques such as those described with reference to FIGS. 12 and 13.

Additionally, those of ordinary skill in the art will recognize that encoding techniques such as those described with reference to FIGS. 10 and 11 can be thought of as an example of encoding techniques such as those described with reference to FIGS. 3 and 4. Referring now to FIG. 3, in some examples, offset generator 216 can be configured to operate such that, for randomly or pseudo-randomly selected symbols, the generated offset is some particular value that causes quantization engine 208 to set the symbol to a predetermined value. With other non-selected symbols, the generated offset is zero.

### Examples of Applications

Examples of some applications in which coding techniques described above may be utilized will now be described.

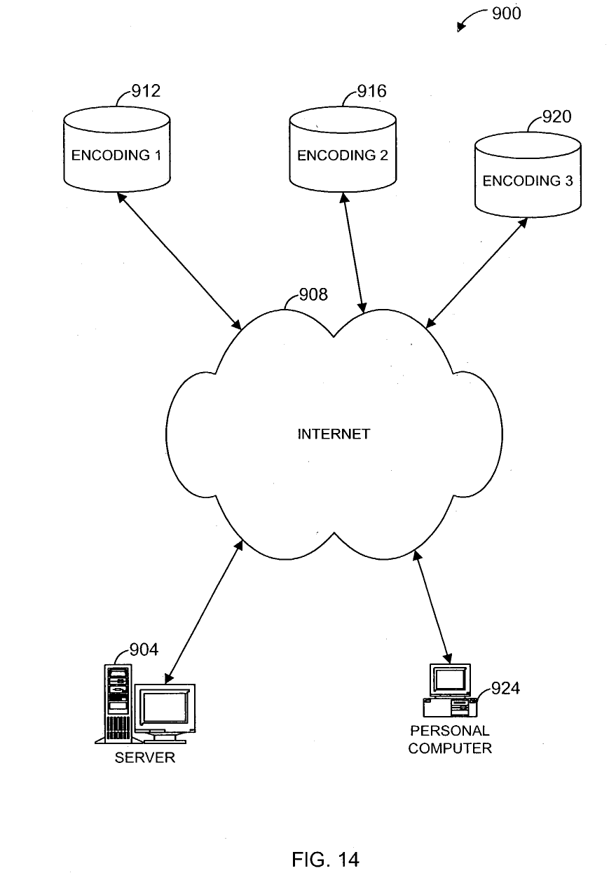

FIG. 14 is a block diagram of an example system 900 that includes a server 904 coupled to the Internet 908. Server 904 generates a plurality of encodings of a data file. These encoding can be generated, for example, according to any of the techniques described with reference to FIGS. 3, 4, 10, and 11. Server 904 may store these encodings at a plurality of locations 912, 916, and 920 coupled to the Internet 908. Locations 912, 916, and 920 may be, for example, servers, personal computers, etc.

Computer system 924 is also coupled to the Internet 908. Computer system 924 may request of server 904 a copy of the data file. In response, server 904 may instruct locations 912, 916, and 920 to transmit the multiple encodings to computer system 924 via the Internet 908. Optionally, server 904 may generate an additional encoding of the data file and transmit it to computer system 924 via the Internet. Upon receiving one or more of the encodings, computer system 924 can decode the data file using a technique such as those described with reference to FIGS. 6, 7, 9, 12, and 13.

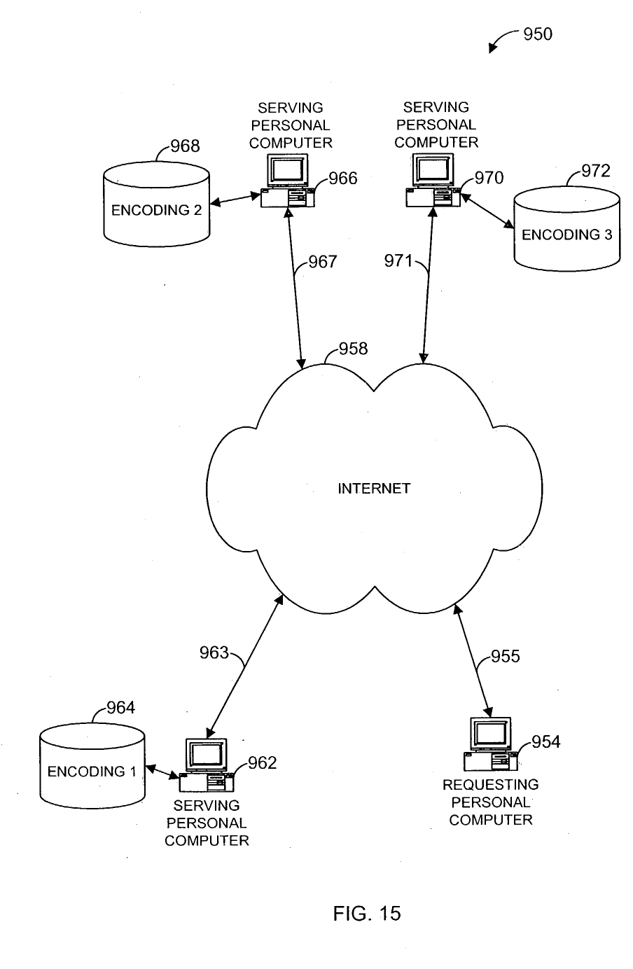

FIG. 15 is a block diagram of another example system in which coding techniques described above may be utilized. System 950 is a peer-to-peer system that includes personal computers 954, 962, 966, and 970, coupled together via the Internet 958, and respective links 955, 963, 967, and 971. Personal computer 954 generates and transmits, via the Internet 958, a request for a data file. This request is received by personal computers 962, 966, and 970, which each have access to an encoded version of the data file. The encoded versions 964, 968, and 972 were generated, for example, according to techniques such as those described with reference to FIGS. 3, 4, 10, and 11.

In response to the request from personal computer 954, personal computers 962, 966, and 970 transmit their respective encodings 964, 968, and 972 to personal computer 954 via the Internet 958. Upon receiving one or more of the encodings, computer system 954 can decode the data file using a technique such as those described with reference to FIGS. 6, 7, 9, 12, and 13.

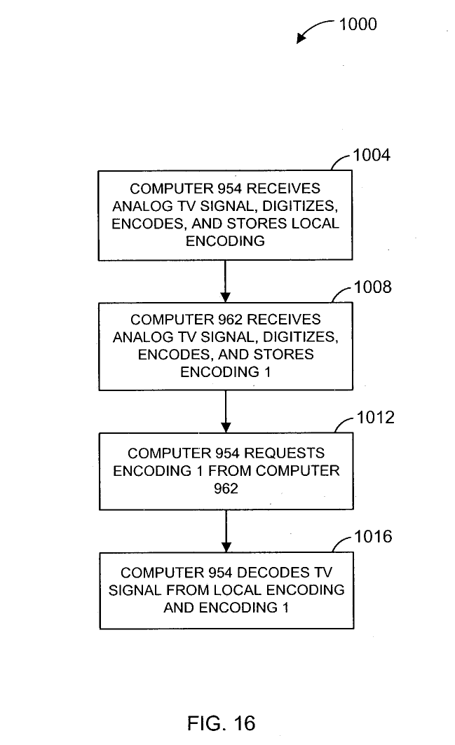

FIG. 16 is a flow diagram of an example method 1000 that may be implemented in a system such as system 950 of FIG. 15. In this example, computers 954 and 962 are capable of receiving and digitizing analog TV signals. At block 1004, computer 954 receives and digitizes an analog TV signal. Additionally, computer 954 encodes the digitized signal using a technique such as those described with reference to FIGS. 3, 4, 10, and 11. Further, computer 954 stores this encoding locally (LOCAL ENCODING).

At block 1008, computer 962 receives and digitizes the analog TV signal. Additionally, computer 962 encodes the digitized signal using a technique such as those described with reference to FIGS. 3, 4, 10, and 11. Further, computer 962 stores this encoding (ENCODING 1).

When a user of computer 954 wishes to view the content from the TV signal, computer 954 requests from computer 962 ENCODING 1 (block 1012). Then, at block 1016, computer 954 decodes the TV signal using the LOCAL ENCODING and ENCODING 1 received from computer 962 according to techniques such as those described with reference to FIGS. 3, 4, 10, and 11.

In the above example, the LOCAL ENCODING stored by computer 954 may require less storage as compared to a high-bandwidth encoding of the TV signal. Additionally, by decoding using ENCODING 1 as well as the LOCAL ENCODING, the quality of the decoded TV signal can be improved as compared to a decoding using LOCAL ENCODING alone.

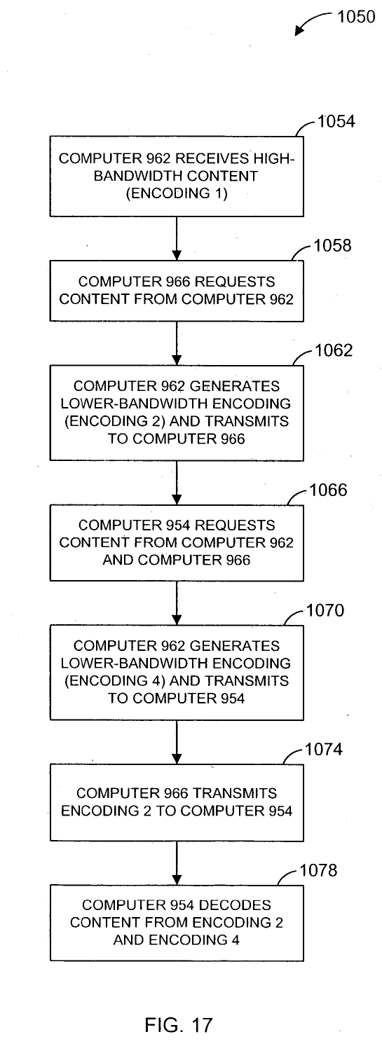

FIG. 17 is a flow diagram of another example method 1050 that may be implemented in a system such as system 950 of FIG. 15. In this example, the link 963 of computer 962 is asymmetric, wherein the bandwidth of the download link is substantially greater than the bandwidth of the upload link.

At block 1054, computer 962 receives a high-bandwidth encoding of a media content file via link 963, and stores the high-bandwidth encoding (ENCODING 1). At block 1058, computer 966 requests computer 962 to serve the media content file to computer 966. The uplink portion of link 963, however, does not have the bandwidth required for computer 962 to serve ENCODING 1. Therefore, at block 1062, computer 962 generates a lower bandwidth encoding (ENCODING 2) of the media content file, and serves ENCODING 2 to computer 966.

At block 1066, computer 954 requests computers 962 and 966 to serve the media content file to computer 954. As described above, the uplink portion of link 963, however, does not have the bandwidth required for computer 962 to serve ENCODING 1. Therefore, at block 1070, computer 962 generates another lower bandwidth encoding (ENCODING 4) of the media content file, and serves ENCODING 4 to computer 954.

Additionally, at block 1074, computer 966 serves ENCODING 2 to computer 954. Next, at block 1078, computer 954 decodes the media content file using ENCODING 4 and ENCODING 2 served by computers 962 and 966, respectively.

While the invention is susceptible to various modifications and alternative constructions, certain illustrative embodiments thereof have been shown in the drawings and are described in detail herein. It should be understood, however, that there is no intention to limit the disclosure to the specific forms disclosed, but on the contrary, the intention is to cover all modifications, alternative constructions and equivalents falling within the spirit and scope of the disclosure as defined by the appended claims.

What is claimed is:

1. A method for dequantizing quantized data, the quantized data including multiple encoded versions of source data, the method comprising:
receiving an initial encoding of the source data, the initial encoding including a sequence of quantized symbols;
receiving at least one additional encoding of the source data, the at least one additional encoding including a sequence of quantized symbols, wherein each of the initial encoding and the at least one additional encoding is independently encoded;
aligning the initial encoding and the at least one additional encoding;
determining a quantization interval of a symbol in the initial encoding;
determining a quantization interval of a corresponding symbol in the at least one additional encoding;
determining an intersection of the quantization intervals of the symbol in the initial encoding and the corresponding symbol in the at least one additional encoding; and
generating a dequantized symbol based on the intersection.

2. A method as defined in claim 1, wherein the sequence of quantized symbols in the initial encoding and the sequence of quantized symbols in the at least one additional encoding include error symbols associated with predicted symbols, the method further comprising:
for each of the error symbols, generating a predicted symbol;
for each of the error symbols, adding the predicted symbol to the error symbol to generate a reconstructed symbol;
wherein, for each of the reconstructed symbols in the initial encoding and in the at least one additional encoding, determining the quantization interval comprises:
determining the quantization interval of the associated error symbol;
determining the quantization interval of the associated predicted symbol;
determining the quantization interval of the reconstructed symbol based on the quantization interval of the associated error symbol and the quantization interval of the associated predicted symbol.

3. A method as defined in claim 1, wherein the initial encoding is encoded using a first varying quantization scale, and the at least one additional encoding is encoded using a second varying quantization scale, wherein the first varying quantization scale varies independently of the second varying quantization scale.

4. A method as defined in claim 1, wherein aligning the initial encoding and the at least one additional encoding comprises correlating the initial encoding and the at least one additional encoding.

5. A method as defined in claim 1, wherein aligning the initial encoding and the at least one additional encoding comprises examining watermarks of the initial encoding and the at least one additional encoding.

6. A method as defined in claim 1, wherein generating the dequantized symbol comprises determining a centroid of the intersection.

7. A tangible medium storing machine readable instructions comprising:
first software to receive an initial encoding of source data, the initial encoding including a sequence of quantized symbols;
second software to receive at least one additional encoding of the source data, the at least one additional encoding including a sequence of quantized symbols, wherein each of the initial encoding and the at least one additional encoding is encoded independently;
third software to align the initial encoding and the at least one additional encoding;
fourth software to determine a quantization interval of a symbol in the initial encoding;
fifth software to determine a quantization interval of a corresponding symbol in the at least one additional encoding;
sixth software to determine an intersection of the quantization intervals of the symbol in the initial encoding and the corresponding symbol in the at least one additional encoding; and
seventh software to generate a dequantized symbol based on the intersection.

8. A tangible medium as defined in claim 7, wherein the initial encoding is encoded using a first varying quantization scale, and the at least one additional encoding is encoded using a second varying quantization scale, wherein the first varying quantization scale varies independently of the second varying quantization scale.

9. A multiple description dequantizer system, comprising:
an aligner to align an initial encoding of source data and at least one additional encoding of the source data, each of the initial encoding and the at least one additional encoding including a sequence of quantized symbols, wherein the initial encoding is encoded independently of the at least one additional encoding;
a quantization interval calculator coupled to the aligner to generate first quantization intervals for quantized symbols associated with the initial encoding and second quantization intervals for quantized symbols associated with the at least one additional encoding;
an interval intersection calculator coupled to the quantization interval calculator to generate intersections of the first and second quantization intervals; and
a dequantization engine coupled to the interval intersection calculator to generate dequantized symbols based on the intersections of the first and second quantization intervals.

10. A multiple description dequantizer system as defined in claim 9, wherein the quantized symbols in the initial encoding and the at least one additional encoding include error symbols associated with predicted symbols, the system further comprising:
a predicted symbol generator to generate an associated predicted symbol for each error symbol;
an adder to add each error symbol with the associated predicted symbol to generate a reconstructed quantized symbol;
wherein the quantization interval calculator is configured to:
generate quantization intervals for the error symbols;
generate quantization intervals for the predicted symbols;
generate quantization intervals for the reconstructed quantized symbols based on a quantization interval of an associated error symbol and a quantization interval of an associated predicted symbol.

11. A multiple description dequantizer system as defined in claim 9, wherein the initial encoding is encoded using a first varying quantization scale, and the at least one additional encoding is encoded using a second varying quantization scale, wherein the first varying quantization scale varies independently of the second varying quantization scale.

12. A method for reconstructing source data from multiple versions of the source data, the method comprising:
receiving an initial version of the source data, the initial version including a first sequence of symbols;
receiving at least one additional version of the source data, the at least one additional version including at least a second sequence of symbols, wherein for each of the first sequence and the at least a second sequence, a respective subset of the symbols is set to a predetermined value, and wherein each respective subset is different than the other subsets;
aligning the first sequence and the at least a second sequence;
generating a reconstructed symbol from a group of symbols, the group of symbols including a first symbol from the first sequence and at least a second symbol, aligned with the first symbol, from the at least a second sequence, including:
if at least one symbol of the group is not of the predetermined value, disregarding symbols of the group that are of the predetermined value, and generating the reconstructed symbol based on symbols of the group that are not of the predetermined value; and
otherwise, setting the reconstructed symbol to the predetermined value.

13. A method as defined in claim 12, wherein generating includes, if the first symbol in the group is not of the predetermined value, setting the reconstructed symbol to the first symbol.

14. A method as defined in claim 13, wherein generating includes, if the first symbol in the group is of the predetermined value and at least one of the other symbols in the group is not of the predetermined value:
selecting one of the symbols in the group not of the predetermined value; and
setting the reconstructed symbol to the selected symbol.

15. A tangible medium storing machine readable instructions comprising:
first software to receive an initial version of the source data, the initial version including a sequence of symbols;
second software to receive at least one additional version of the source data, the at least one additional version including a sequence of symbols, wherein for each of the initial version and the one or more additional versions, a respective subset of the symbols is set to a predetermined value, and wherein each respective subset is different than the other subsets;
third software to align the initial version and the at least one additional version;
fourth software to generate a reconstructed symbol corresponding to a group of aligned symbols from the initial version and the at least one additional version, including:
fifth software to disregard symbols of the group of aligned symbols of the predetermined value, and to generate the corresponding reconstructed symbol based on symbols of the group not of the predetermined value, if at least one symbol of the group of aligned symbols is not of the predetermined value; and
sixth software to set the reconstructed symbol to the predetermined value, otherwise.

16. A tangible medium storing machine readable instructions as defined in claim 15, wherein the fifth software includes seventh software to set the reconstructed symbol to the symbol in the group of aligned symbols from the initial version if the symbol in the group of aligned symbols from the initial version is not of the predetermined value.

17. A decoding system for reconstructing source data from multiple encoded versions of the source data, the decoder comprising:
an aligner to align an initial encoding of source data and at least one additional encoding of the source data, the initial encoding including a first sequence of symbols, the at least one additional encoding including a second sequence of symbols;
a decoder coupled to the aligner and configured to:
set a reconstructed symbol corresponding to a symbol in the first sequence to a predetermined value if the corresponding symbol in the first sequence and a corresponding symbol in the second sequence are of the predetermined value; and
otherwise, generate the reconstructed symbol based on at least one of the corresponding symbols in the first and second sequences.

18. A decoding system as defined in claim 17, wherein the decoder is configured to set the reconstructed symbol to the symbol in the group of aligned symbols from the initial version if the symbol in the group of aligned symbols from the initial version is not of the predetermined value.

19. A method for encoding data for use in a multiple-description coding system, the method comprising:
receiving an ordered sequence of symbols;
randomly or pseudo-randomly varying quantization scales; and
quantizing the ordered sequence of symbols based on the varying quantization scales.

20. A method as defined in claim 19, wherein varying quantization scales includes varying each quantization scale.

21. A method as defined in claim 19, wherein randomly or pseudo-randomly varying quantization scales includes setting randomly or pseudo-randomly selected quantization scales to a first predetermined value;
wherein quantizing the ordered sequence of symbols includes setting symbols corresponding to the quantization scales of the first predetermined value to a second predetermined value.

22. A method as defined in claim 21, wherein the second predetermined value is zero.

23. A method as defined in claim 21, wherein quantizing the ordered sequence of symbols includes leaving symbols corresponding to the quantization scales not set to the first predetermined value unchanged.

24. A method as defined in claim 21, wherein the randomly or pseudo-randomly selected quantization scales are selected based on a seed.

25. A method as defined in claim 19, wherein varying includes:
generating a quantization scale base;
generating a randomly or pseudo-randomly varying quantization scale offset; and
adding the quantization scale base to the varying quantization scale offset.

26. A method as defined in claim 19, further comprising:
receiving a seed;
wherein the quantization scale is pseudo-randomly varied based on the seed.

27. A tangible medium storing machine readable instructions comprising:
first software to receive an ordered sequence of symbols;
second software to vary, randomly or pseudo-randomly, quantization scales; and
third software to quantize the ordered sequence of symbols based on the varying quantization scales.

28. A tangible medium as defined in claim 27, wherein the second software includes:
fourth software to generate a quantization scale base;
fifth software to generate a randomly or pseudo-randomly varying quantization scale offset; and
sixth software to add the quantization scale base to the varying quantization scale offset.

29. An encoder system for encoding data for use in a multiple-description coding system, the encoding system comprising:
a quantization scale generator to generate randomly or pseudo-randomly varying quantization scales; and
a quantization engine, coupled to receive the varying quantization scales and an ordered sequence of symbols, to generate an ordered sequence of quantized symbols based on the varying quantization scales.

30. An encoder system as defined in claim 29, wherein the quantization scale generator includes:
a quantization scale base generator to generate a quantization scale base;
a quantization scale offset generator to generate a randomly or pseudo-randomly varying a quantization scale offset; and
an adder to add the quantization scale base and the quantization scale offset.

31. A method for generating multiple encodings of data for use in a multiple-description coding system, the method comprising:
instructing a first quantizer to randomly or pseudo-randomly vary first quantization scales;
instructing the first quantizer to quantize a first ordered sequence of symbols based on the first varying quantization scales to generate a first ordered sequence of quantized symbols;
instructing a second quantizer to randomly or pseudo-randomly vary second quantization scale; and
instructing the second quantizer to quantize a second ordered sequence of symbols based on the second varying quantization scales to generate a second ordered sequence of quantized symbols;
wherein the first ordered sequence of symbols and the second ordered sequence symbols are generated from substantially the same source data.

32. A method as defined in claim 31, wherein the first ordered sequence of symbols and the second ordered sequence symbols are generated from the same source data.

33. A method as defined in claim 31, wherein the first ordered sequence of symbols is generated from a base source data with a first noise signal and the second ordered sequence symbols is generated from the base source data with a second noise signal.

34. A method as defined in claim 31, wherein instructing the first quantizer to randomly or pseudo-randomly vary the first quantization scales includes providing the first quantizer with a first seed;
wherein instructing the second quantizer to randomly or pseudo-randomly vary the second quantization scales includes providing the second quantizer with a second seed.

35. A method as defined in claim 31, wherein the first quantizer and the second quantizer are a single quantizer.

36. A tangible medium storing machine readable instructions comprising:
first software to instruct a first quantizer to randomly or pseudo-randomly vary a first quantization scale;
second software to instruct the first quantizer to quantize a first ordered sequence of symbols based on the first varying quantization scale to generate a first ordered sequence of quantized symbols;
third software to instruct a second quantizer to randomly or pseudo-randomly vary a second quantization scale; and
fourth software to instruct the second quantizer to quantize a second ordered sequence of symbols based on the second varying quantization scale to generate a second ordered sequence of quantized symbols;
wherein the first ordered sequence of symbols and the second ordered sequence symbols are generated from substantially the same source data.

37. A tangible medium as defined in claim 36, wherein the first ordered sequence of symbols and the second ordered sequence symbols are generated from the same source data.

38. A method for encoding data for use in a multiple-description coding system, the method comprising:
receiving an ordered sequence of symbols;
randomly or pseudo-randomly determining a subset of symbols in the ordered sequence of symbols; and
setting the subset of symbols to a predetermined value.

39. A method as defined in claim 38, further comprising:
receiving a seed;
wherein the subset of symbols is determined pseudo-randomly based on the seed.

40. A tangible medium storing machine readable instructions comprising:
first software to receive an ordered sequence of symbols;
second software to determine, randomly or pseudo-randomly, a subset of symbols in the ordered sequence of symbols; and
third software to set the subset of symbols to a predetermined value.

41. A tangible medium as defined in claim 40, further comprising:
fourth software to receive a seed;
wherein the second software includes fourth software to determine the subset of symbols pseudo-randomly based on the seed.

42. An encoder system for encoding data for use in a multiple-description coding system, the encoding system comprising:
a symbol indication generator to randomly or pseudo-randomly generate indications of symbols in an ordered sequence symbols; and
an encoding engine, coupled to receive the indications and the ordered sequence of symbols, to set symbols in the ordered sequence of symbols corresponding to the indications to a predetermined value.

43. An encoder system as defined in claim 42, wherein the symbol indication generator randomly or pseudo-randomly generate indications of symbols based on the seed.

44. A method for generating multiple encodings of data for use in a multiple-description coding system, the method comprising:
instructing a first encoder to randomly or pseudo-randomly determine a subset of symbols in a first ordered sequence of input symbols;
instructing the first encoder to set the subset of symbols in the first ordered sequence of input symbols to a predetermined value to generate a first ordered sequence of output symbols;
instructing a second encoder to randomly or pseudo-randomly determine a subset of symbols in a second ordered sequence of input symbols; and
instructing the second encoder to set the subset of symbols in the second ordered sequence of input symbols to the predetermined value to generate a second ordered sequence of output symbols;
wherein the first ordered sequence of symbols and the second ordered sequence symbols are generated from substantially the same source data.

45. A method as defined in claim 44, wherein instructing the first encoder to randomly or pseudo-randomly determine the subset of symbols includes providing the first encoder with a first seed;
wherein instructing the second encoder to randomly or pseudo-randomly determine the subset of symbols includes providing the second encoder with a second seed.

46. A method as defined in claim 44, wherein the first encoder and the second encoder are a single encoder.

47. A tangible medium storing machine readable instructions comprising:
first software to instruct a first encoder to randomly or pseudo-randomly determine a subset of symbols in a first ordered sequence of input symbols;
second software to instruct the first encoder to set the subset of symbols in the first ordered sequence of input symbols to a predetermined value to generate a first ordered sequence of output symbols;
third software to instruct a second encoder to randomly or pseudo-randomly determine a subset of symbols in a second ordered sequence of input symbols; and
fourth software to instruct the second encoder to set the subset of symbols in the second ordered sequence of input symbols to the predetermined value to generate a second ordered sequence of output symbols;
wherein the first ordered sequence of symbols and the second ordered sequence symbols are generated from substantially the same source data.

48. A tangible medium as defined in claim 47, wherein the first encoder and the second encoder are a single encoder.

49. A video decoder, comprising:
a first entropy decoder, to receive an initial video encoding and to generate an initial sequence of quantized discrete cosign transform (DCT) symbols;
at least a second entropy decoder, to receive at least one additional video encoding, and to generate at least one additional sequence of quantized DCT symbols, wherein the initial encoding is encoded independently of the at least one additional encoding;
an aligner, coupled to the first entropy decoder and to the at least a second entropy decoder, to align the initial sequence of quantized DCT symbols and the at least one additional sequence of quantized DCT symbols;
a quantization interval calculator coupled to the aligner to generate first quantization intervals for quantized DCT symbols in initial sequence and at least second quantization intervals for quantized DCT symbols in the at least one additional sequence;
an interval intersection calculator coupled to the quantization interval calculator to generate intersections of the first and at least second quantization intervals; and
a dequantization engine coupled to the interval intersection calculator to generate dequantized DCT symbols based on the intersections of the first and second quantization intervals.

50. A video decoder as defined in claim 49, wherein the first entropy decoder and the least a second entropy decoder are a single entropy decoder.

51. A video encoder for encoding data for use in a multiple-description coding system, the video encoder comprising:
a discrete cosign transform (DCT) generator to receive video data and to generate DCT symbols;
a quantizer, coupled to the DCT generator, including:
a quantization scale generator to generate a randomly or pseudo-randomly varying a quantization scale; and
a quantization engine, coupled to receive the varying quantization scale and the DCT symbols, to generate quantized DCT symbols based on the varying quantization scale.

52. A video encoder as defined in claim 51, wherein the quantization scale generator includes:
a quantization scale base generator to generate a quantization scale base;
a quantization scale offset generator to generate a randomly or pseudo-randomly varying a quantization scale offset; and
an adder to add the quantization scale base and the quantization scale offset.

53. A method for delivering data via a multiple-description coding system, the method comprising:
providing an ordered sequence of symbols to each of a plurality of encoders, wherein at least some of the plurality of encoders are distributed within a network;
at the plurality of encoders, randomly or pseudo-randomly varying quantization scales;
at each of the plurality of encoders, quantizing the ordered sequence of symbols based on the varying quantization scales; and
at each of the plurality of encoders, transmitting the respective ordered sequence of quantized symbols to a decoder via the network.

54. A method as defined in claim 53, wherein the quantization scales are varied by at least some of the plurality of encoders independently of the quantization scales of other of the plurality of encoders.

55. A method as defined in claim 53, wherein the network comprises a wide area network.

56. A method as defined in claim 53, wherein the network comprises a local area network.
